(19) United States
(12) Patent Application Publication
(10) Pub. No.: US 2016/0243548 A1
(43) Pub. Date: Aug. 25, 2016

(54) MICROFLUIDICS SORTER FOR CELL DETECTION AND ISOLATION

(71) Applicant: CLEARBRIDGE BIOMEDICS PTE LTD, Singapore (SG)

(72) Inventors: Ali Asgar Bhagat, Singapore (SG); Guofeng Guan, Singapore (SG)

(73) Assignee: Clearbridge BioMedics Pte Ltd, Singapore (SG)

(21) Appl. No.: 15/029,629

(22) PCT Filed: Oct. 16, 2014
(86) PCT No.: PCT/SG2014/000487

§ 371 Date: Apr. 15, 2016

(30) Foreign Application Priority Data
Oct. 16, 2013 (SG) 201307805-0

(51) Int. Cl. B01L 3/00

(52) U.S. Cl. CPC B01L 3/502715; B01L 2200/0689; B01L 2300/12; B01L 2300/041; B01L 2200/027; B01L 2200/141; B01L 2300/0861; B01L 2300/08; B01L 2200/12; B01L 2200/10; B01L 2300/0809

(57) ABSTRACT

An interface comprising: a plurality of external ports configured to fluidically communicate with a plurality of ports of a fluidic delivery platform; and a plurality of engaging conduits configured to fluidically communicate with a plurality of ports of a microfluidic biochip, wherein a tolerance of both the plurality of external ports and/or the plurality of engaging conduits is significantly tighter than a tolerance of the plurality of ports of the microfluidic biochip.

### CROSS-REFERENCE TO RELATED APPLICATIONS

This U.S. non-provisional patent application is a U.S. national stage application, which was filed on Apr. 15, 2016 under 35 U.S.C. §371 and claims priority to PCT Patent Application No. PCT/SG2014/000487, which was filed on Oct. 16, 2014, and claims priority to Singapore Patent Application No. SG201307805-0, which was filed on Oct. 16, 2013. The contents of PCT Patent Application No. PCT/SG2014/000487 and Singapore Patent Application No. SG201307805-0 are incorporated herein by reference in their entirety.

### FIELD

The invention relates to an interface for use with a microfluidic device.

### BACKGROUND

Microfluidics based systems have evolved from being fabricated using glass/silicon to polymers. The polymer fabrication methods have replaced techniques borrowed from the microelectronics industry (MEMS), making their manufacturing simpler and cheaper. The biocompatibility of polymers makes them an attractive choice of material for lab-on-a-chip (LOC) or point-of-care (POC) devices for many diagnostics applications. Polydimethylsiloxane (PDMS), a soft rubber like polymer, has emerged as a popular material in research and academia to fabricate/manufacture microfluidics devices over traditional hard plastics such as, for example, polycarbonate (PC), poly methyl methacrylate (PMMA), polypropylene (PP), and polystyrene. A PDMS based microfluidic chip is appropriate for manual machining mainly due to low cost of manufacture. PDMS also has excellent optical, mechanical and chemical properties. Moreover, PDMS has high repeatability and accuracy over injection moulding, which also makes it a desirable material for the mass fabrication of the microfluidic chip with micro to sub-micro patterns that require high dimensional accuracy.

However, as microfluidics based devices have been rapidly developed over the last decade, interconnects to interface these devices with macro-world such as, for example, syringes, syringe pumps, pressure pumps, and the like still remains a technical challenge. Also, interconnects do not readily scale and often make the device bulky. This coupled with the pliant nature of PDMS makes this issue extremely challenging. The small size of the microfluidic devices typically warrants a custom solution and there is usually no ‘one size fits all’ packaging scheme for PDMS based devices. Unlike integrated circuits (IC) chips, there are no standards for microfluidics device packaging.

In this regard, PDMS is typically not the desired material when transitioning a microfluidic device from lab to commercial form. The pliant characteristics of PDMS make compression based clamping extremely difficult to achieve leak proof seals. Plastic chips made of hard material are typically preferred when evolving a lab set-up to an automated instrument with integrated fluid delivery modules. This is because it is easier to interface the hard plastic chips with fluid delivery instruments compared to a PDMS microfluidic chip. However, investment in time and money for production of hard plastic chips is substantial and this has usually been a barrier to successful microfluidic chip commercialization. Clearly, there is an issue when transitioning a microfluidic device transitions from lab to commercial form.

### SUMMARY

In general terms the invention proposes a non deformable interface for a deformable microfluidic chip. This may have the advantage that the ports in the interface can be made tight tolerance and can be made to easily mate with the loose tolerance ports on the chip during manufacturing. The tight tolerance interface ports may therefore be able to easily mate with a fluid delivery platform and/or using a compression seal.

In a specific expression of the invention there is provided an interface comprising:
a plurality of external ports configured to fluidically communicate with a plurality of ports of a fluidic delivery platform; and
a plurality of engaging conduits configured to fluidically communicate with a plurality of ports of a microfluidic biochip,
wherein a tolerance of both the plurality of external ports and/or the plurality of engaging conduits is significantly tighter than a tolerance of the plurality of ports of the microfluidic biochip.

Embodiments may be implemented according to any of claims 2 to 16.

### DESCRIPTION OF FIGURES

In order that the present invention may be fully understood and readily put into practical effect, there shall now be described by way of non-limitative example only preferred embodiments of the present invention, the description being with reference to the accompanying illustrative figures.

FIG. 1 shows a first perspective view of an interface of an example embodiment.

FIG. 2 shows a first photograph of the interface.

FIG. 3 shows a second perspective view of the interface.

FIG. 4 shows a second photograph of the interface.

FIG. 5 shows a front view of a cover usable with the interface.

FIG. 6 shows a photograph of the cover.

FIG. 7 shows a photograph of the cover and the interface laid side-by-side.

FIG. 8 shows a photograph of the cover and the interface from an opposite side to the view shown in FIG. 7.

FIG. 9 shows a photograph of a manifold set-up for assessing the interface.

FIG. 10 shows a schematic view for a pressure test set-up.

FIG. 11 shows a photograph of the pressure test set-up of FIG. 10.

FIGS. 12(a) to (d) show a sequence of images for coupling the interface with a biochip.

FIG. 13 shows a photograph of the interface undergoing compression.

FIG. 14 shows a section view of the interface coupled to a manifold of the fluid delivery platform, with the interface undergoing compression.

### DETAILED DESCRIPTION

Embodiments may provide an interface with ports that allows a PDMS based microfluidic device to interface readily and reliably with a fluidic delivery platform. The interface is able to overcome issues which arise whenever a fluidic delivery platform is required to interface with a PDMS based microfluidic device. Consequently, the interface may serve as a basis for a variety of economical solutions involving microfluidic devices.

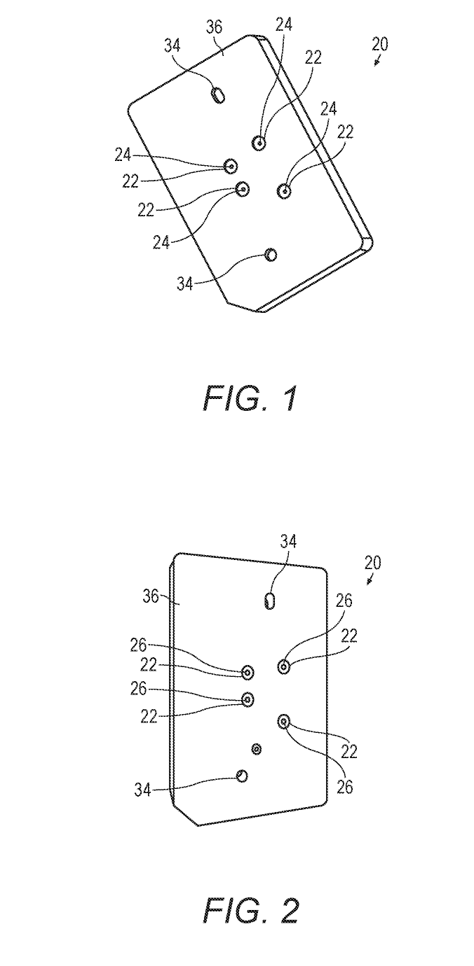

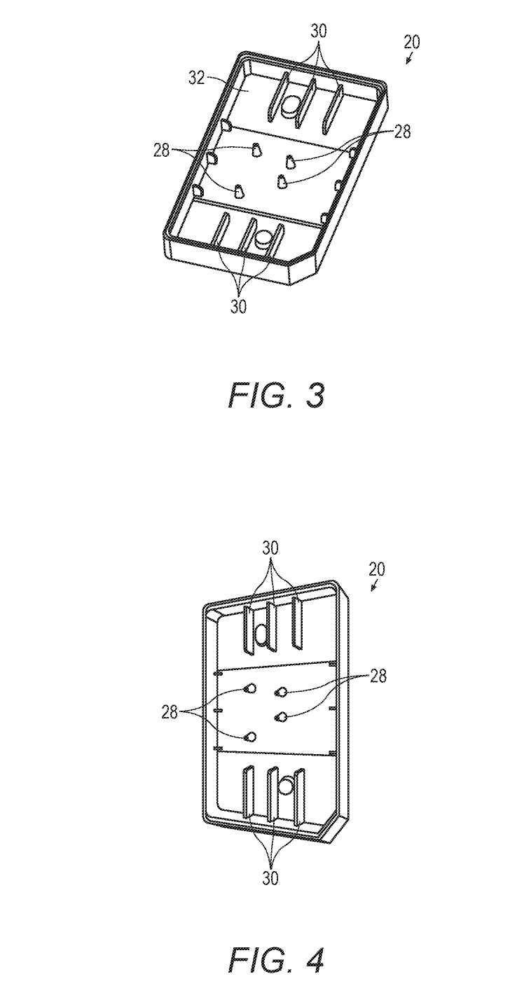

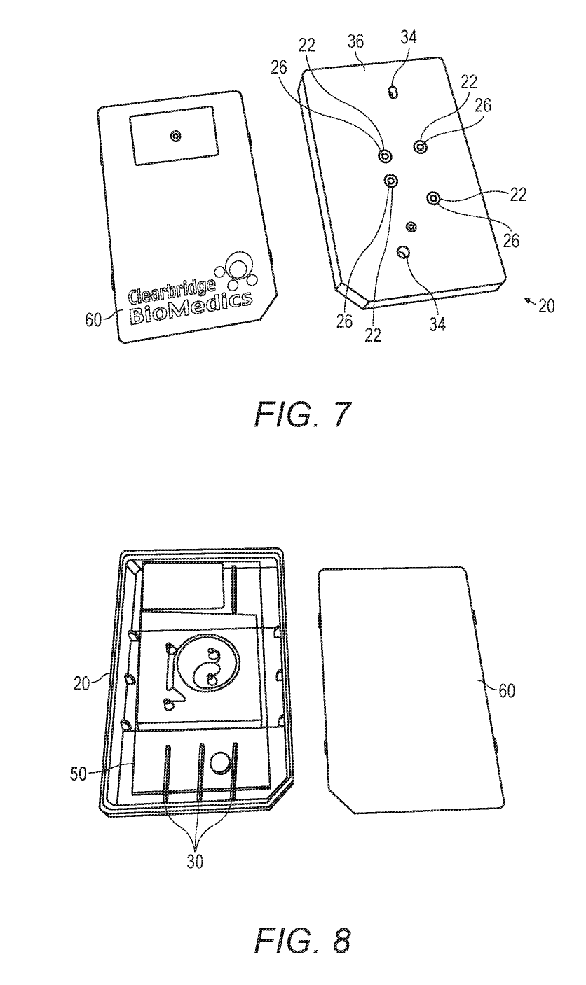

Referring to FIGS. 1 to 8, there is provided various views of an interface 20 with ports, showing either illustrations or photographs of respective components/portions of the interface 20. The interface 20 comprises a plurality of external ports 22 configured to fluidically communicate with a plurality of ports of a fluidic delivery platform (not shown). Specifically, the plurality of external ports 22 typically interfaces with a manifold on an instrument integrated with the fluidic delivery platform, such as, for example, pressure pumps, syringe pumps, and so forth. Each of the plurality of external ports 22 includes a recess 24 configured for affixing an o-ring 26. Alternatively, gaskets, washers or similar objects are used to provide a leak proof seal while under compression. The o-rings 26 are used for providing a seal with the manifold. The diameter/depth of the recess is approximately 0.2-0.6 mm smaller than an outer diameter of the o-rings 26 to ensure that the o-rings are able to sit within the each recess 24 tightly. The interface 20 also includes at least one receptor 34 at an outer surface 36 for aligning the interface 20 with the manifold of the fluidic delivery platform.

The interface 20 also comprises a plurality of engaging conduits 28 which are configured to fluidically communicate with a plurality of ports of a microfluidic biochip 50. Each of the plurality of engaging conduits 28 is of a frusto-conical shape and each engaging conduit 28 is co-axial with an external port 22. Each external port 22 is configured to fluidically communicate with each co-axial engaging conduit 28. The external ports 22 provide through-hole access to the engaging conduits 28 within the interface 20. These external ports 22 align with ports on the manifold of the fluid delivery platform (specifically an instrument integrated with the fluid delivery platform), fluidically connecting the microfluidic biochip 50 with the fluid delivery platform. The fluid can be any liquid or gas being pumped into the microfluidic biochip 50. It is possible that the fluid is a biological sample such as, for example, blood, saliva, pleural effusion, urine, and so forth being pumped into the microfluidic chip 50 for diagnostic applications.

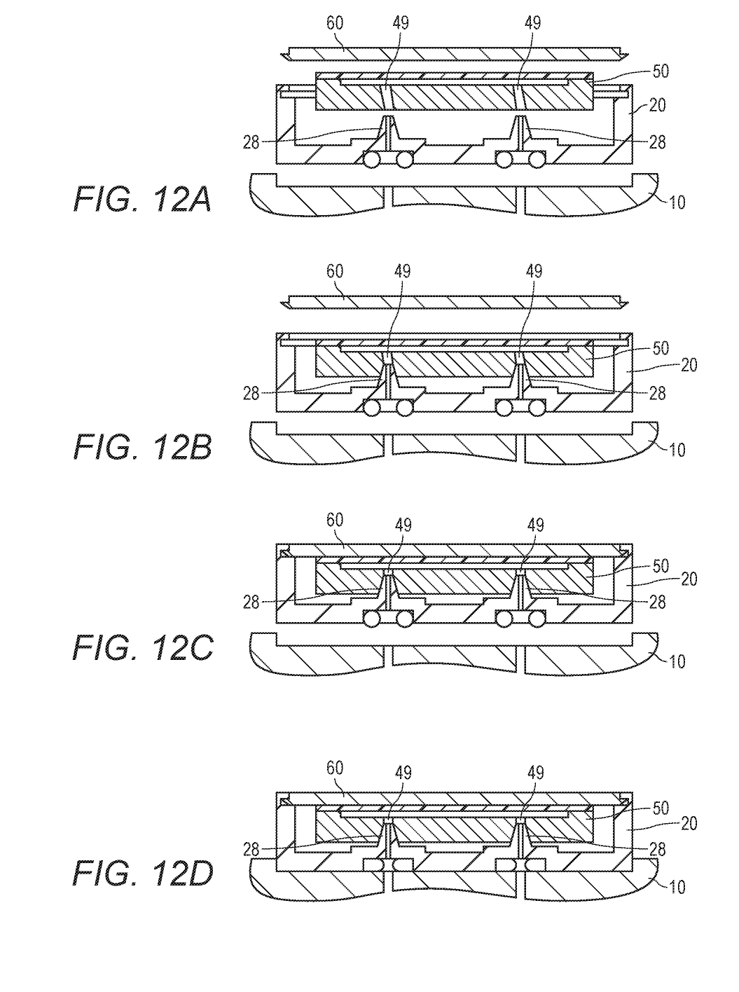

Each of the plurality of engaging conduits 28 mates with each of the plurality of ports of the microfluidic biochip 50 to provide a leak-proof seal. FIG. 12 shows the external port 22 and the engaging conduit 28 sharing a channel 25 of uniform diameter. However, the diameters of the external port 22 and the engaging conduit 28 can be different so long as flow rates are kept moderate (eg:, 0.01 to 5 ml/min) to avoid turbulent flow. Also keeping the diameters of the external port 22 and the engaging conduit 28 relatively uniform avoids a high shear environment which can damage cells. An open end 29 of the engaging conduit 28 has a smaller diameter compared to an interface end 27. The plurality of ports 49 of the microfluidic biochip 50 are distorted due to shrinkage of material during the curing process. During engagement, the open end 29 forces the deformable ports 49 to mate and provide a leak-proof seal against the interface end 27 as shown in FIGS. 12(a)-(d).

Since the microfluidic biochip 50 is typically made from PDMS, each of the plurality of ports 49 of the microfluidic biochip 50 can be fitted to (mates with) each of the plurality of engaging conduits 28 to provide the leak-proof seal when the microfluidic biochip is aligned in an appropriate manner with the interface 20 as shown in FIG. 8.

The microfluidic biochip 50 can have varying dimensions (thickness, width, breadth). It should be appreciated that the external surfaces of the four engaging conduits 28 may also act as alignment features for the microfluidic biochip 50. A depth of insertion (depth of each engaging conduit 28 being inserted into each port 49 of the chip 50) when fitting (mating) the plurality of ports 49 of the microfluidic biochip 50 to the engaging conduits 28 is determined by a thickness of the PDMS mould and a height of the interface 20.

The desired range of the inclination angles of each engaging conduit 28 is between 0° to 15°. Each engaging conduit 28 has a frusto-conical shape with the open end 29 having an external diameter of between 0.1 mm to 1 mm smaller that a diameter of the ports 49. Each engaging conduit 28 is mated to the ports 49 such that they are inserted to between 50 to 90% of the thickness of the microfluidic biochip 50. The interface end 27 external diameter of each engaging conduit 28 is between 0.2 mm to 1.5 mm larger than the diameter of the ports 49 to ensure good compression seal between the engaging conduits 28 and the ports 49.

It should be appreciated that connection of the plurality of external ports 22 to the manifold is more easily carried out compared to mating of the plurality of engaging conduits 28 to the microfluidic biochip 50. This is due primarily to the micro dimensions and flexibility of the ports 49 of the microfluidic biochip 50 which leads to greater difficulty when mating to the plurality of engaging conduits 28 of the interface 20. The positions of the plurality of external ports 22 and the plurality of engaging conduits 28 are fixed on the interface 20. Given that the ports 49 of the microfluidic biochip 50 are flexible, the ports 49 of the microfluidic biochip 50 are able to mate with and be secured to the affixed plurality of engaging conduits 28 to ensure that the interface 20 can be used to enable fluidic communication between the fluid delivery platform and the microfluidic biochip 50. In this regard, a tolerance (in relation to the physical configuration) of both the plurality of external ports 22 and the plurality of engaging conduits 28 is significantly tighter (more accurate or dependable) than a tolerance (in relation to the physical configuration) of the plurality of ports 49 of the microfluidic biochip 50 (more prone to deformation due to curing). Thus the high variance of the plurality of ports 49 may be accommodated due to the tight tolerance of the external ports 22 and engaging conduits 28. The tolerance of the PDMS thickness is ±0.5 mm. Due to the 2 to 5% shrinkage of the PDMS during the curing process, the tolerance of the plurality of the ports can also reach ±0.5 mm. The interface 20, dimensional tolerance can be controlled to within ±0.1 mm in all the directions depending on the moulding technique and material used.

The interface 20 is fabricated from a hard plastic such as, for example, PC, PMMA, PVC, HDPE, LDPE, PS, PP and the like. The interface 20 can be readily manufactured using economical and scalable processes such as, for example, injection moulding or other plastic moulding techniques. The interface 20 is non-deformable and also includes a plurality of rib structures 30 at an inner surface 32 of the interface 20. The plurality of rib structures 30 at the inner surface 32 provide structural rigidity and prevent the interface 20 from collapsing and consequently damaging the attached microfluidic biochip 50 when undergoing high compression loads. This is essential as a high compression load is necessary to achieve a good seal between the interface 20 and the microfluidic chip 50. Without the interface 20, it would be very challenging to apply a constant load to the microfluidic chip 50 without occurrence of significant deformation and damage to the microfluidic chip 50.

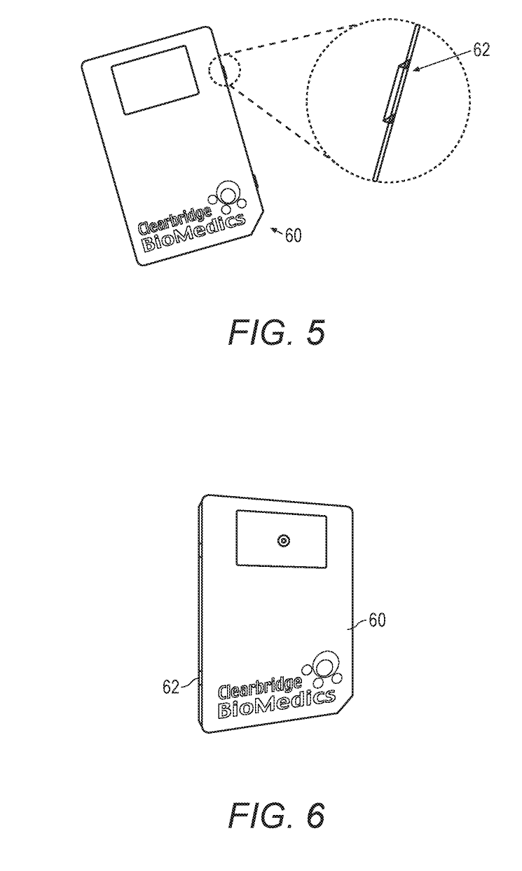

Once the microfluidic chip 50 is mated to the interface 20, the interface 20 subsequently sealed with a cover 60 (which is shown in FIGS. 5 and 6). During assembly, the microfluidic chip 50 is manually aligned approximately to the plurality of engaging conduits 28 as shown in FIG. 12(a). Then the chip 50 is pressed onto the engaging conduits 28 so that the deformable ports 49 are forced to mate as shown in FIG. 12(b). Finally the cover 60 is then closed to secure the microfluidic chip 50 as shown in FIG. 12(c). The cover 60 is able to be permanently secured (locked) to the interface 20 using at least one tamper-proof lock 62 integrated with the cover 60. This will ensure reliability and prevent reuse. Depending on the thickness of the chip 50, it is possible it may be suspended within the cover 60 from the compression fit to the engaging conduits 28. As such the interface 20 can be a standard size to accommodate a range of different models of chip 50. For higher pressure applications, it may be designed to press against the bottom of the inside of cover 60 to ensure the seal is not forced apart during use.

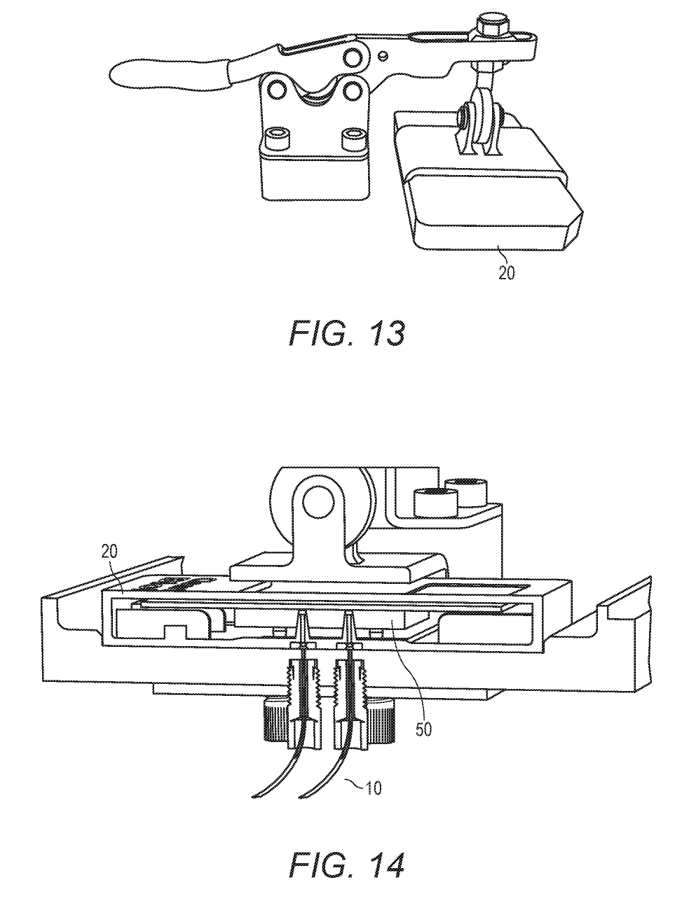

FIGS. 12(d), 13 and 14 shows the interface 20 undergoing compression coupled to a manifold 10 of the fluid delivery platform. The o-rings 26 are compressed and thus provide a high reliability seal form the manifold 10 to the microfluidic chip 50.

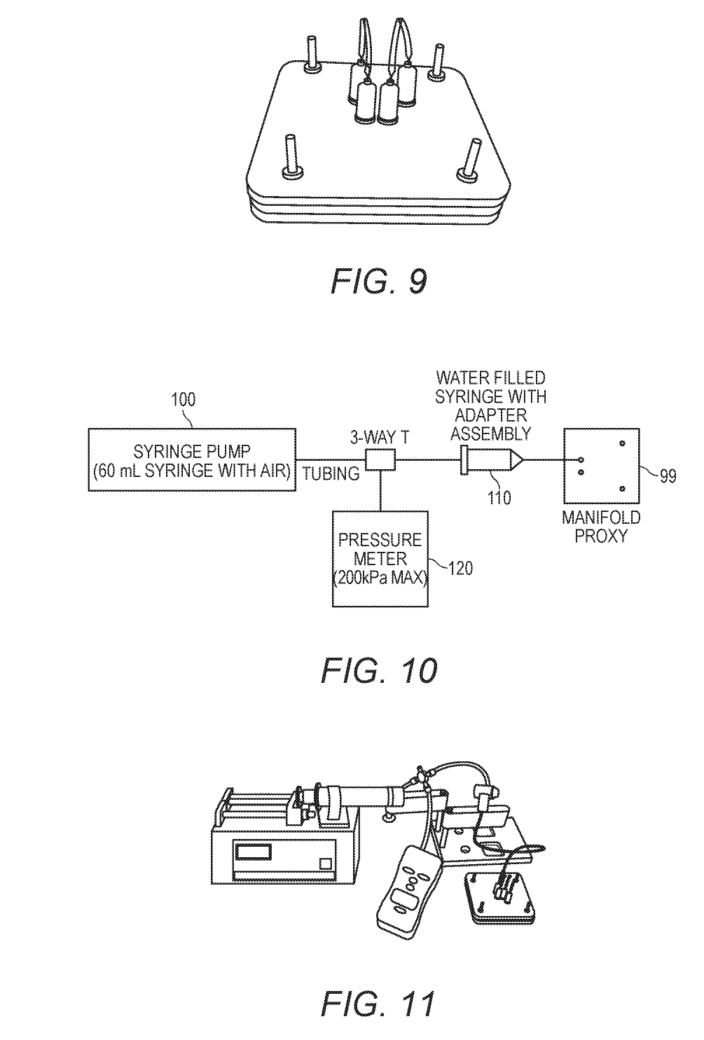

Testing is carried out to determine a maximum pressure that the interface 20 can withstand. A manifold 99 was fabricated using aluminum (as shown in FIG. 9) to simulate typical interfacing of a microfluidic based automated system. The manifold 99 is connected to a primary syringe 100 and a pressure meter 120 during testing, as shown schematically in FIG. 10. The actual set-up is shown in FIG. 11. The primary syringe 100 filled with air drives a plunger of a secondary syringe (with adaptor assembly) 110 filled with water. The pressure in the secondary syringe 110 is allowed to build up. The pressure meter 120 which is able to measure up to 200 kPa is connected using a 3-way T-junction to measure the built-up pressure in the secondary syringe 110. During testing, with a load of 30 N being applied to the manifold 99, the primary syringe 100 is allowed to pump at 10 ml/min and the pressure of the system is monitored. The primary syringe 100 also has a maximum pressure rating of 200 kPa after which it stalls in operation returning an error state. The interface 20 is shown to be successfully able to withstand up to 200 kPa of pressure for at least 15 min using the aforementioned set-up. The test set-up may be for both testing proof of concept and quality control of the interface 20 during manufacturing/assembly.

It is appreciated that the interface 20 may provide one or more advantages:

- Able to provide a blockage-free seal which is typically prevalent in adhesive/glue based alternatives;

- Low cost since the interface 20 can be made from economical processes and materials;

- Repeatability since the interface 20 is able to sufficiently protect the microfluidic biochip 50 which is mated to the interface 20;

- Low dead volume—important when working with low sample volumes and expensive reagents since wastage of the aforementioned liquids is minimized when using the interface 20;

- Able to withstand high pressure of approximately 200 kPa which ensures a good seal between the interface 20 and the microfluidic chip 50; and

- Scalable manufacturing due to the low cost of production.

Whilst there have been described in the foregoing description preferred embodiments of the present invention, it will be understood by those skilled in the technology concerned that many variations or modifications in details of design or construction may be made without departing from the present invention.

1. An interface comprising:
a microfluidic biochip contained within the interface;
a plurality of external ports configured to fluidically communicate with a plurality of ports of a fluidic delivery platform; and
a plurality of engaging conduits configured to fluidically communicate with a plurality of ports of the microfluidic biochip,
wherein the engaging conduits are of a frustro-conical shape,
wherein a tolerance of both the plurality of external ports and/or the plurality of engaging conduits is significantly tighter than a tolerance of the plurality of ports of the microfluidic biochip,
wherein the interface is fabricated from a hard plastic selected from a group consisting of: hard plastic, PC, PMMA, PVC, HDPE, LDPE, PS and PP, and
wherein the interface is configured to be sealed with a non-removable cover.

2. The interface of claim 1, wherein each of the plurality of external ports includes a recess configured for a seal selected from a group consisting of: an o-ring, a gasket and a washer.

3. The interface of claim 1, further comprising a plurality of rib structures at an inner surface of the interface.

4. The interface of claim 1, further comprising at least one receptor at an outer surface, the at least one receptor being configured for aligning the interface with a manifold of the fluidic delivery platform.

5.-7. (canceled)

8. The interface of claim 1, wherein the interface is substantially non-deformable.

9. The interface of claim 1, wherein each external port is co-axial with each engaging conduit, with each external port being configured to fluidically communicate with each co-axial engaging conduit.

10. The interface of claim 1, wherein the plurality of engaging conduits mates with the plurality of ports of a microfluidic biochip to provide a leak-proof seal.

11. The interface of claim 1, wherein an inclination angle of each engaging conduit is between 0° to 15°.

12. The interface of claim 1, wherein an open end of each engaging conduit has an external diameter of between 0.1 mm to 1 mm smaller than an internal diameter of the plurality of ports of the microfluidic biochip.

13. The interface of claim 1, wherein an interface end of each engaging conduit has an external diameter of between 0.2 mm to 1.5 mm larger than a diameter of the plurality of ports of the microfluidic biochip.

14. (canceled)

15. The interface of claim 1 further comprising a tamper proof lock to permanently prevent the microfluidic biochip being removed from the interface.

16. The interface of claim 1, where the microfluidic biochip is made of polydimethylsiloxane (PDMS) or pliant soft polymer material.

17. A fluidic delivery platform or diagnostic apparatus configured to form a compression seal with an external port of an interface according to claim 1.
